(19) United States
(12) Patent Application Publication
(10) Pub. No.: US 2024/0208011 A1
(43) Pub. Date: Jun. 27, 2024

(54) RATCHET WRENCH

(71) Applicant: Infar Industrial Co., Ltd., Chang-Hua County (TW)

(72) Inventor: Tai Hung Chen, Chang-Hua County (TW)

(21) Appl. No.: 18/490,163

(22) Filed: Oct. 19, 2023

(30) Foreign Application Priority Data
Dec. 26, 2022 (TW) 111150023

(51) Int. Cl. B25B 13/46

(52) U.S. Cl. CPC B25B 13/463

(57) ABSTRACT

A ratchet wrench includes a body, a ratchet wheel, and a clamping assembly. The body has a ratchet hole. The ratchet wheel is rotatably mounted in the ratchet hole and has a driving hole, a containing hole, and a toggle portion. The containing hole extends along a radial direction to communicate the driving hole and an outer periphery of the ratchet wheel. The toggle portion is disposed around the outer periphery of the ratchet wheel. The clamping assembly includes an engaging member and a resilient ring. The engaging member is arranged in the containing hole to selectively enter or exit the driving hole. The resilient ring surrounds around the outer periphery of the ratchet wheel and abuts against the engaging member.

### BACKGROUND OF THE INVENTION

The present invention relates to ratchet wrenches, and more specifically refers to a ratchet wrench capable of rapidly rotating.

Taiwan Patent No. TWM548048U discloses a ratchet wrench, which includes a wrench body, a ratchet device, and at least one hexagon screwdriver bit. The wrench body has a head portion and a handle portion integrally extending to a suitable length. The head portion has a bottom surface provided with a chamber being concave upwardly vertically, and a top surface penetrating a through hole to communicate with the chamber. The through hole is gradually reduced in its diameter relative to the chamber to form a step edge between the through hole and the chamber. The ratchet device includes a driving head installed in the chamber and a pawl installed inside the head portion and controlled by a reversing switcher. The driving head has an outer periphery provided with an outer annular teeth portion, and a hexagonal shaped driving hole penetrating through the center thereof. The hexagon screwdriver bit has a top edge having a chamfered section to form a reduced diameter portion, and a bottom edge extending to a specific-shaped operating rod.

However, the ratchet wrench cannot secure socket the hexagon screwdriver bit, especially the hexagon screwdriver bit provided with an annular groove on its outside is not suitable for the ratchet wrench.

Thus, a need exists for a ratchet wrench to mitigate and/or obviate the above disadvantages.

### SUMMARY OF THE INVENTION

An objective of the present invention is to provide a ratchet wrench, which includes a body, a ratchet wheel, and a clamping assembly. The body has a ratchet hole extending along a rotating axis. The ratchet wheel is rotatably mounted in the ratchet hole, and has a driving hole, a containing hole, and a toggle portion. The driving hole extends along the rotating axis. The containing hole extends along a radial direction of the rotating axis to communicate the driving hole and an outer periphery of the ratchet wheel. The toggle portion is disposed around the outer periphery of the ratchet wheel about the rotating axis. The clamping assembly includes an engaging member and a resilient ring. The engaging member is arranged in the containing hole to selectively enter or exit the driving hole. The resilient ring surrounds around the outer periphery of the ratchet wheel and abuts against the engaging member.

In an embodiment, the body defines a first end surface and a second end surface along the rotating axis. The ratchet hole communicates the first end surface and the second end surface. The ratchet wheel has a bottom end protruding outside the first end surface and provided with the driving hole, and a top end protruding outside the second end surface and provided with the toggle portion.

In an embodiment, the outer periphery of the ratchet wheel is provided with an annular recess about the rotating axis, and the annular recess is disposed adjacent to the first end surface. The resilient ring is circular and is mounted to the annular recess.

In an embodiment, one end of the ratchet wheel opposite to the driving hole is provided with a through hole extending along the rotating axis and communicating with the driving hole. The driving hole has a first width in the radial direction of the rotating axis. The through hole has a second width in the radial direction of the rotating axis. The second width is less than the first width.

In an embodiment, the body is provided with a pawl groove, a switch groove, and a positioning slot. The switch groove extends along a pivoting axis parallel to the rotating axis. A positioning member is arranged in the positioning slot. The ratchet wrench further comprises a ratchet pawl assembly and a switcher. The ratchet pawl assembly includes a first pawl and a second pawl both arranged in the pawl groove to alternatively engage with the ratchet wheel. The switcher has a lever portion and a pivoting portion integrally formed with the lever portion. The pivoting portion is pivotally mounted in the switch groove, allowing the switcher to pivot relative to the body between a first position and a second position. The lever portion protrudes outside the switch groove. The switcher has a first positioning recess and a second positioning recess. The positioning member abuts against the first positioning recess when the switcher is in the first position. The positioning member abuts against the second positioning recess when the switcher is in the second position. An inner periphery of the switch groove is provided with a first fastening recess, an outer periphery of the pivoting portion is provided with a second fastening recess corresponding to the first fastening recess, and a fastening ring is engaged with the pivoting portion and is arranged in the first fastening recess and the second fastening recess.

In an embodiment, the positioning slot extends along a direction parallel to the pivoting axis, allowing the positioning member movable in the positioning slot along the direction parallel to the pivoting axis. The positioning slot is formed on a bottom surface of the switch groove and communicates with the switch groove. The first positioning recess and the second positioning recess are formed on a bottom end face of the pivoting portion distal to the lever portion.

In an embodiment, a biasing member is arranged in the positioning slot. The biasing member has a first end biasing against a bottom of the positioning slot, and a second end biasing against the positioning member.

In an embodiment, the ratchet pawl assembly includes an elastic member having a first end abutting against the first pawl, and a second end abutting against the second pawl. The switcher drives the first pawl to move and to disengage from the ratchet wheel and the elastic member bias against the second pawl to move and to engage with the ratchet wheel when the switcher is in the first position. The switcher drives the second pawl to move and to disengage from the ratchet wheel and the elastic member bias against the first pawl to move and to engage with the ratchet wheel when the switcher is in the second position.

In an embodiment, the pawl groove communicates with the switch groove. The first pawl has a first protrusion. The second pawl has a second protrusion. The pivoting portion has an abutting recess. The abutting recess abuts against the first protrusion when the switcher is in the first position. The abutting recess abuts against the second protrusion when the switcher is in the second position.

In an embodiment, an inner periphery of the driving hole has two opposite faced surfaces, and a width defined between the two opposite faced surfaces is ¼ in, 5/16 in, 7/19 in, or 4 mm.

The present invention will become clearer in light of the following detailed description of illustrative embodiments of this invention described in connection with the drawings.

### BRIEF DESCRIPTION OF DRAWINGS

FIG. 1 is a perspective view of a ratchet wrench of an embodiment according to the present invention.

FIG. 2 is an exploded perspective view of the ratchet wrench of FIG. 1.

FIG. 3 is a cross sectional view of the ratchet wrench of FIG. 1.

FIG. 4 is another cross sectional view of the ratchet wrench of FIG. 1.

FIG. 5 is a cross sectional view of the ratchet wrench and shows a switcher in a first position.

FIG. 6 is another cross sectional view of the ratchet wrench and shows the switcher in a second position.

### DETAILED DESCRIPTION OF THE INVENTION

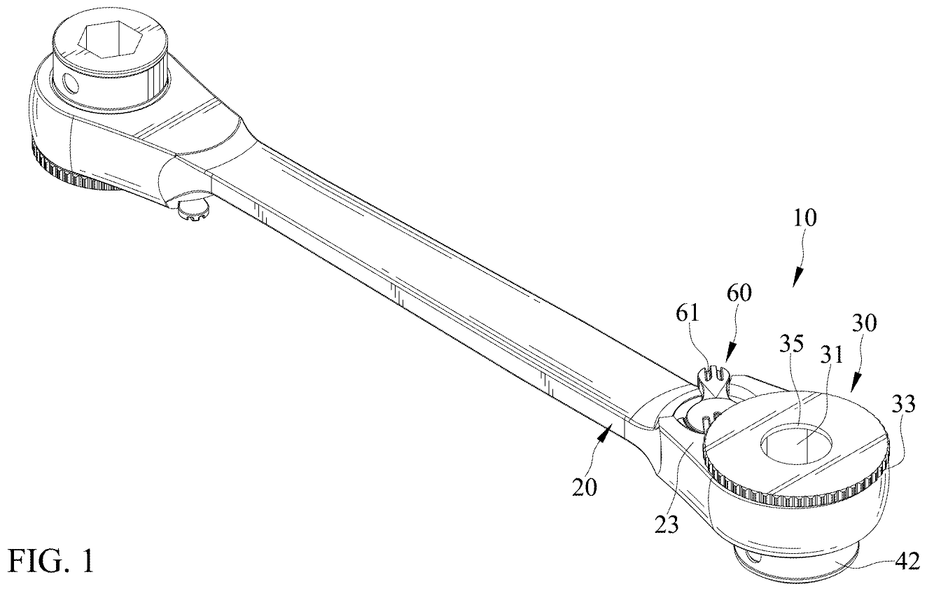

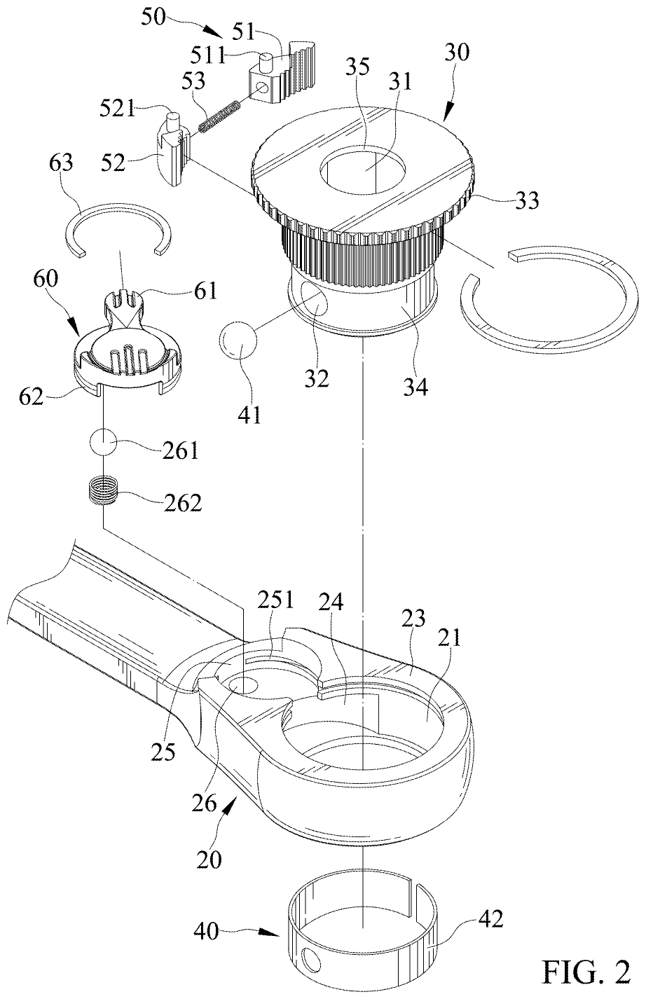

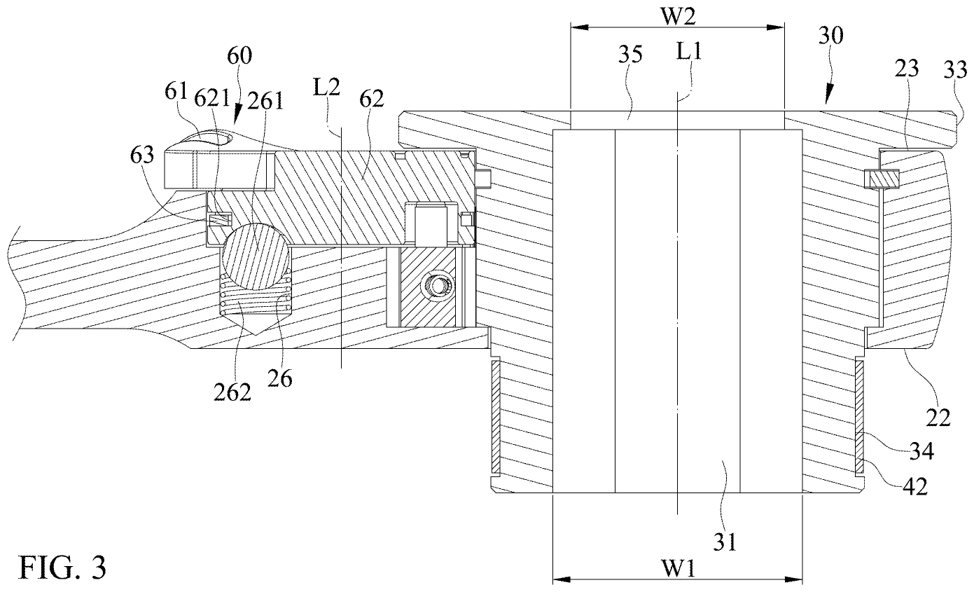

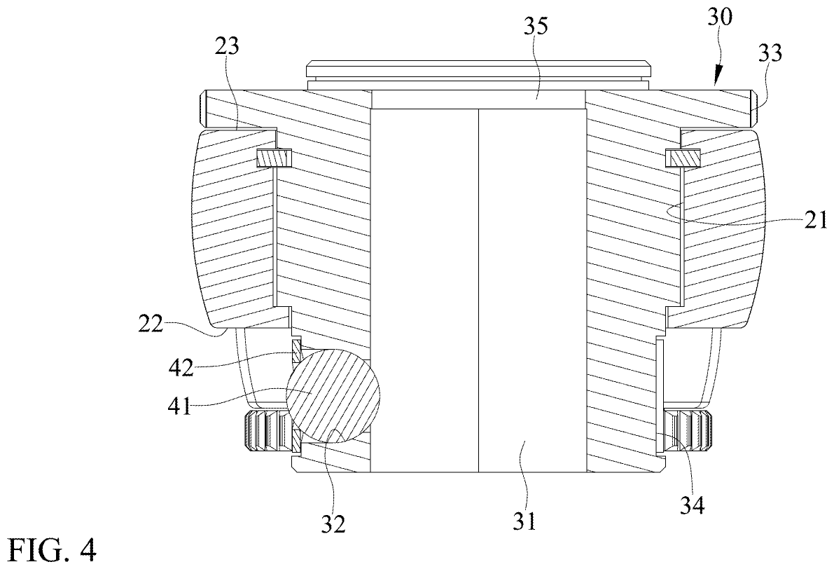

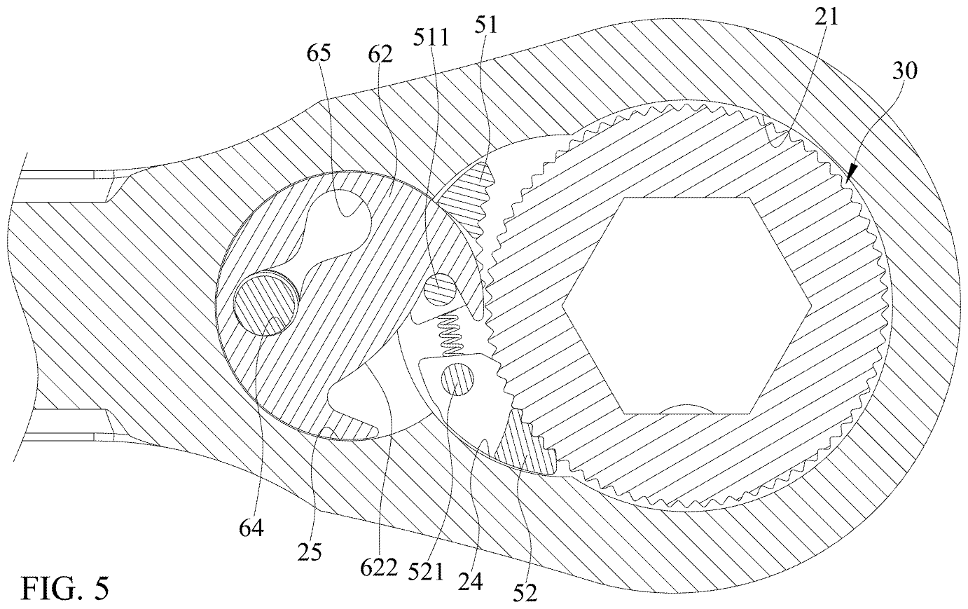

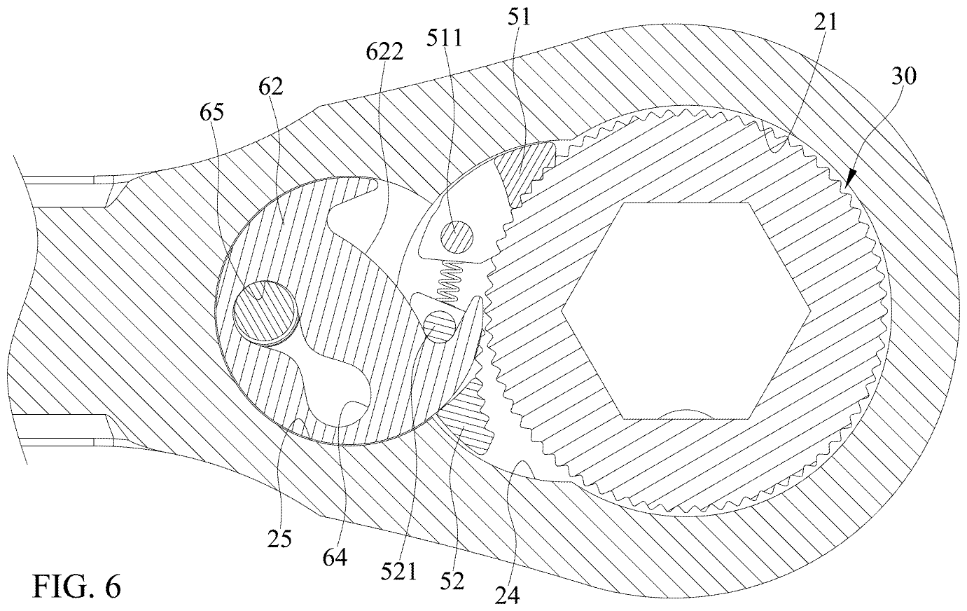

FIGS. 1-6 show a ratchet wrench 10 of an embodiment according to the present invention. The ratchet wrench 10 includes a body 20, a ratchet wheel 30, and a clamping assembly 40.

The body 20 has a ratchet hole 21 extending along a rotating axis L1.

The ratchet wheel 30 is rotatably mounted in the ratchet hole 21 about the rotating axis L1. The ratchet wheel 30 has a driving hole 31, a containing hole 32, and a toggle portion 33. The driving hole 31 extends along the rotating axis L1. The containing hole 32 extends along a radial direction of the rotating axis L1 to communicate the driving hole 31 and an outer periphery of the ratchet wheel 30. The toggle portion 33 is disposed around the outer periphery of the ratchet wheel 30 about the rotating axis L1.

The clamping assembly 40 includes an engaging member 41 and a resilient ring 42. The engaging member 41 is arranged in the containing hole 32 to selectively enter or exit the driving hole 31. The resilient ring 42 surrounds around the outer periphery of the ratchet wheel 30 and abuts against the engaging member 41.

The body 20 defines a first end surface 22 and a second end surface 23 along the rotating axis L1. The ratchet hole 21 communicates the first end surface 22 and the second end surface 23. The ratchet wheel 30 has a bottom end protruding outside the first end surface 22 and provided with the driving hole 31, and a top end protruding outside the second end surface 23 and provided with the toggle portion 33.

The outer periphery of the ratchet wheel 30 is provided with an annular recess 34 about the rotating axis L1. The annular recess 34 is disposed adjacent to the first end surface 22. The resilient ring 42 is circular and is mounted to the annular recess 34.

One end of the ratchet wheel 30 opposite to the driving hole 31 is provided with a through hole 35 extending along the rotating axis L1 and communicating with the driving hole 31. The driving hole 31 has a first width W1 in the radial direction of the rotating axis L1. The through hole 35 has a second width W2 in the radial direction of the rotating axis L1. The second width W2 is less than the first width W1.

The body 20 is provided with a pawl groove 24, a switch groove 25, and a positioning slot 26. The switch groove 25 extends along a pivoting axis L2 parallel to the rotating axis L1, and an inner periphery of the switch groove 25 is provided with a first fastening recess 251. A positioning member 261 is arranged in the positioning slot 26. The ratchet wrench 10 further includes a ratchet pawl assembly 50 and a switcher 60. The ratchet pawl assembly 50 includes a first pawl 51 and a second pawl 52 arranged in the pawl groove 24 to alternatively engage with the ratchet wheel 30. The switcher 60 has a lever portion 61 and a pivoting portion 62 integrally formed with the lever portion 61. The pivoting portion 62 is pivotally mounted in the switch groove 25, allowing the switcher 60 to pivot relative to the body 20 between a first position and a second position. The lever portion 61 protrudes outside the switch groove 25, and an outer periphery of the pivoting portion 62 is provided with a second fastening recess 621 corresponding to the first fastening recess 251. A fastening ring 63 is engaged with the pivoting portion 62 and is arranged in the first fastening recess 251 and the second fastening recess 621. The switcher 60 has a first positioning recess 64 and a second positioning recess 65. The positioning member 261 abuts against the first positioning recess 64 when the switcher 60 is in the first position, and the positioning member 261 abuts against the second positioning recess 65 when the switcher 60 is in the second position.

The positioning slot 26 extends along a direction parallel to the pivoting axis L2, allowing the positioning member 261 movable in the positioning slot 26 along the direction parallel to the pivoting axis L2. The positioning slot 26 is formed on a bottom surface of the switch groove 25 and communicates with the switch groove 25. The first positioning recess 64 and the second positioning recess 65 are formed on a bottom end face of the pivoting portion 62 distal to the lever portion 61.

A biasing member 262 is arranged in the positioning slot 26, and has a first end biasing against a bottom of the positioning slot 26, and a second end biasing against the positioning member 261.

The ratchet pawl assembly 50 includes an elastic member 53 having a first end abutting against the first pawl 51, and a second end abutting against the second pawl 52. The switcher 60 drives the first pawl 51 to move and to disengage from the ratchet wheel 30 and the elastic member 53 bias against the second pawl 52 to move and to engage with the ratchet wheel 30 when the switcher 60 is in the first position, and the switcher 60 drives the second pawl 52 to move and to disengage from the ratchet wheel 30 and the elastic member 53 bias against the first pawl 51 to move and to engage with the ratchet wheel 30 when the switcher 60 is in the second position.

The pawl groove 24 communicates with the switch groove 25. The first pawl 51 has a first protrusion 511, and the second pawl 52 has a second protrusion 521. The pivoting portion 62 has an abutting recess 622. The abutting recess 622 abuts against the first protrusion 511 when the switcher 60 is in the first position, and the abutting recess 622 abuts against the second protrusion 521 when the switcher 60 is in the second position.

An inner periphery of the driving hole 31 has two opposite faced surfaces, and a width defined between the two opposite faced surfaces is ¼ in, 5/16 in, 7/19 in, or 4 mm.

Therefore, the ratchet wrench 10 presses against a tool bit through the engaging member 41 to be compatible with both manual tool bits without circular grooves and pneumatic tool bits with circular grooves. Further, the toggle portion 33 can also allow the user to rapidly rotate the ratchet wheel 30.

Although specific embodiments have been illustrated and described, numerous modifications and variations are still possible without departing from the scope of the invention. The scope of the invention is limited by the accompanying claims.

1. A ratchet wrench comprising:
a body having a ratchet hole extending along a rotating axis;
a ratchet wheel rotatably mounted in the ratchet hole, wherein the ratchet wheel has a driving hole, a containing hole, and a toggle portion, wherein the driving hole extends along the rotating axis, wherein the containing hole extends along a radial direction of the rotating axis to communicate the driving hole and an outer periphery of the ratchet wheel, and wherein the toggle portion is disposed around the outer periphery of the ratchet wheel about the rotating axis; and
a clamping assembly including an engaging member and a resilient ring, wherein the engaging member is arranged in the containing hole to selectively enter or exit the driving hole, and wherein the resilient ring surrounds around the outer periphery of the ratchet wheel and abuts against the engaging member.

2. The ratchet wrench as claimed in claim 1, wherein the body defines a first end surface and a second end surface along the rotating axis, wherein the ratchet hole communicates the first end surface and the second end surface, and wherein the ratchet wheel has a bottom end protruding outside the first end surface and provided with the driving hole, and a top end protruding outside the second end surface and provided with the toggle portion.

3. The ratchet wrench as claimed in claim 2, wherein the outer periphery of the ratchet wheel is provided with an annular recess about the rotating axis, wherein the annular recess is disposed adjacent to the first end surface, and wherein the resilient ring is circular and is mounted to the annular recess.

4. The ratchet wrench as claimed in claim 1, wherein one end of the ratchet wheel opposite to the driving hole is provided with a through hole extending along the rotating axis and communicating with the driving hole, wherein the driving hole has a first width in the radial direction of the rotating axis, wherein the through hole has a second width in the radial direction of the rotating axis, and wherein the second width is less than the first width.

5. The ratchet wrench as claimed in claim 1, wherein the body is provided with a pawl groove, a switch groove, and a positioning slot, wherein the switch groove extends along a pivoting axis parallel to the rotating axis, wherein a positioning member is arranged in the positioning slot, wherein the ratchet wrench further comprises a ratchet pawl assembly and a switcher, wherein the ratchet pawl assembly includes a first pawl and a second pawl arranged in the pawl groove to alternatively engage with the ratchet wheel, wherein the switcher has a lever portion and a pivoting portion integrally formed with the lever portion, wherein the pivoting portion is pivotally mounted in the switch groove, allowing the switcher to pivot relative to the body between a first position and a second position, wherein the lever portion protrudes outside the switch groove, wherein the switcher has a first positioning recess and a second positioning recess, wherein the positioning member abuts against the first positioning recess when the switcher is in the first position, and wherein the positioning member abuts against the second positioning recess when the switcher is in the second position.

6. The ratchet wrench as claimed in claim 5, wherein an inner periphery of the switch groove is provided with a first fastening recess, wherein an outer periphery of the pivoting portion is provided with a second fastening recess corresponding to the first fastening recess, and wherein a fastening ring is engaged with the pivoting portion and is arranged in the first fastening recess and the second fastening recess.

7. The ratchet wrench as claimed in claim 5, wherein the positioning slot extends along a direction parallel to the pivoting axis, allowing the positioning member movable in the positioning slot along the direction parallel to the pivoting axis, wherein the positioning slot is formed on a bottom surface of the switch groove and communicates with the switch groove, wherein the first positioning recess and the second positioning recess are formed on a bottom end face of the pivoting portion distal to the lever portion.

8. The ratchet wrench as claimed in claim 5, wherein a biasing member is arranged in the positioning slot, and wherein the biasing member has a first end biasing against a bottom of the positioning slot, and a second end biasing against the positioning member.

9. The ratchet wrench as claimed in claim 5, wherein the ratchet pawl assembly includes an elastic member having a first end abutting against the first pawl, and a second end abutting against the second pawl, wherein the switcher drives the first pawl to move and to disengage from the ratchet wheel and the elastic member bias against the second pawl to move and to engage with the ratchet wheel when the switcher is in the first position, and wherein the switcher drives the second pawl to move and to disengage from the ratchet wheel and the elastic member bias against the first pawl to move and to engage with the ratchet wheel when the switcher is in the second position.

10. The ratchet wrench as claimed in claim 5, wherein the pawl groove communicates with the switch groove, wherein the first pawl has a first protrusion, wherein the second pawl has a second protrusion, wherein the pivoting portion has an abutting recess, wherein the abutting recess abuts against the first protrusion when the switcher is in the first position, and wherein the abutting recess abuts against the second protrusion when the switcher is in the second position.

11. The ratchet wrench as claimed in claim 5, wherein an inner periphery of the driving hole has two opposite faced surfaces, and wherein a width defined between the two opposite faced surfaces is ¼ in, 5/16 in, 7/19 in, or 4 mm.
